(19) United States
(12) Patent Application Publication
(10) Pub. No.: US 2004/0089831 A1
(43) Pub. Date: May 13, 2004

(54) Fuel injection device for an internal combustion engine, comprising a magneto armature made of cobalt and iron

(76) Inventors: Laurent Chretien, Lyon (FR); Regis Blanc, Tassin (FR); Hubert Greif, Markgroeningen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/311,883

(22) PCT Filed: Apr. 13, 2002
(86) PCT No.: PCT/DE02/01388

(30) Foreign Application Priority Data
Apr. 24, 2001 (DE) 101 19 984.8

(51) Int. Cl. F16K 31/02

(52) U.S. Cl. 251/129.15; 137/375; 251/368

(57) ABSTRACT

The fuel injection apparatus has at least one solenoid valve (50) for controlling the fuel injection. The solenoid valve (50) is triggered by an electrical control unit (52) and has a magnetic coil (88) and a movable magnetic armature (88). The magnetic armature (80) can move a valve element (56) between at least two positions. The magnetic armature (88) is at least essentially comprised of an alloy, which at least contains iron and cobalt, wherein the cobalt content is between 10% and 50%. The control unit (52) evaluates the chronological progression of the current conduction through the magnetic coil (88) and based on it, determines the time of a switching state of the solenoid valve (50) at which a fuel injection begins.

Prior Art

The invention is based on a fuel injection apparatus for an internal combustion engine as generically defined by the preamble to claim 1.

A fuel injection apparatus of this kind is known from DE 196 53 055 C1. This fuel injection apparatus has a solenoid valve to control the fuel injection. The solenoid valve controls a connection of a working chamber of the fuel injection apparatus to a relief chamber, the solenoid valve being open when it is without current, so that the working chamber is connected to the relief chamber and high pressure for a fuel injection cannot build up in this working chamber. When supplied with current, the solenoid valve closes so that the working chamber is shut off from the relief chamber and high pressure builds up in it, leading to a fuel injection. The solenoid valve is triggered by an electric control device and has a magnetic coil and a movable magnetic armature. The magnetic armature is connected to a valve element, which controls the connection to the relief chamber. If, while the magnetic coil is being supplied with current, the valve element reaches its closed position and the magnetic armature is no longer moving, then this can be detected by the control unit based on a characteristic change in the progression of the current conduction through the magnetic coil. The magnetic properties of the magnetic armature and therefore of the material of which it is comprised are of crucial importance to the formation of this characteristic change in the current conduction and consequently to the production of a definite signal.

### ADVANTAGES OF THE INVENTION

The fuel injection apparatus according to the invention, with the characterizing features of claim 1, has the advantage over the prior art that due to the material of which it is comprised, the magnetic armature produces the required characteristic change in the current conduction and as a result, permits the time at which the solenoid valve closes to be detected with a high degree of precision.

Advantageous embodiments and modifications of the fuel injection apparatus according to the invention are disclosed in the dependent claims. The modifications according to claims 3 to 9 prevent wear on the magnetic armature.

### DRAWINGS

A number of exemplary embodiments of the invention are shown in the drawings and will be explained in detail in the subsequent description.

FIG. 1 shows a simplified depiction of a fuel injection apparatus for an internal combustion engine, with a solenoid valve,

FIG. 2 shows an enlarged depiction of the solenoid valve,

FIG. 3 shows an enlarged depiction of a magnetic armature of the solenoid valve according to a modified embodiment, and

FIG. 4 shows the magnetic armature according to another modified embodiment.

### DESCRIPTION OF THE EXEMPLARY EMBODIMENTS

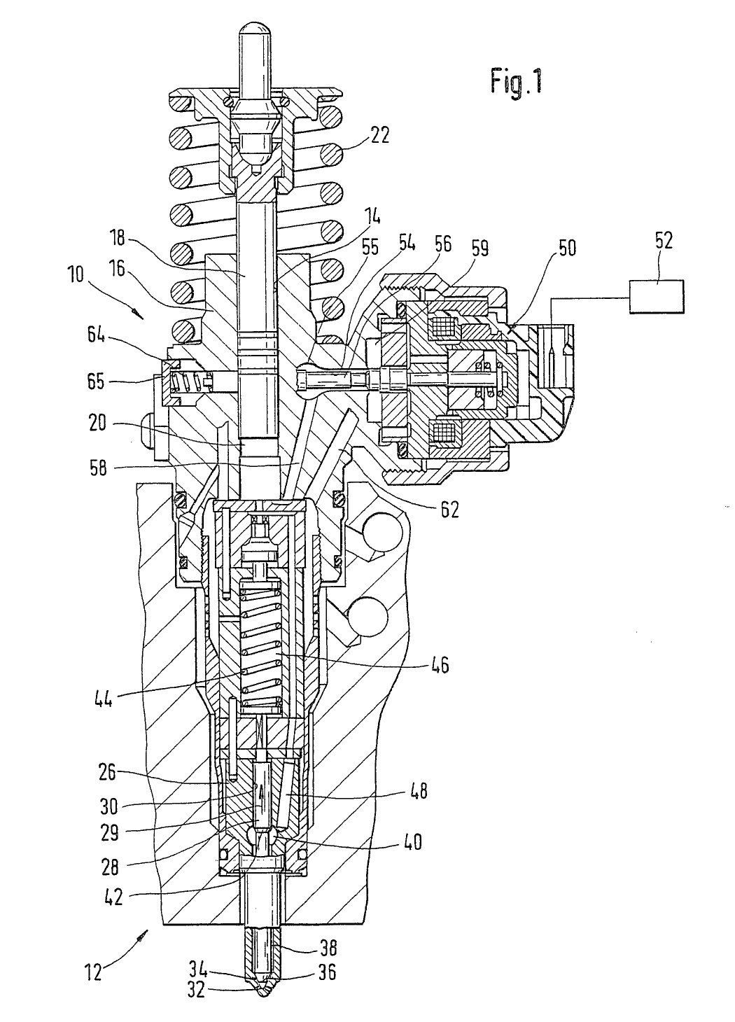

FIG. 1 shows a fuel injection apparatus for an internal combustion engine, in particular for a motor vehicle. The fuel injection apparatus has a fuel pump 10 and a fuel injection valve 12, which are incorporated into a combined component and form a so-called unit injector, which is inserted into a bore in the cylinder head of the engine, the fuel injection valve 12 protruding into the combustion chamber of a cylinder of the engine. The fuel pump 10 has a pump piston 18, which is guided so that it can move axially in a cylinder bore 14 of a pump body 16 and delimits a pump working chamber 20 in the cylinder bore 14, and fuel is compressed at high pressure in this pump working chamber 20 during the delivery stroke of the pump piston 18. During the intake stroke of the pump piston 18, fuel is supplied to the pump working chamber 20 from a fuel tank. A cam drive of the engine, not shown in detail, drives the pump piston 18 in a stroke motion counter to the force of a return spring 22.

The fuel injection valve 12 has a valve body 26, which can be comprised of several parts and is connected to the pump body 16. The valve body 26 has a bore 30 in which an injection valve element 28 is guided in a longitudinally mobile fashion. The bore 30 extends at least approximately parallel to the cylinder bore 14 of the pump body 16, but can also extend at angle in relation to it. In its end region oriented toward the combustion chamber of the cylinder, the valve body 26 has at least one, preferably several, injection openings 32. In its end region oriented toward the combustion chamber, the injection valve element 28 has a for example approximately conical sealing surface 34, which cooperates with a valve seat 36, which is likewise approximately conical, for example, and is embodied in the end region of the valve body 26 oriented toward the combustion chamber, and the injection openings 32 lead away from this valve seat 36 or branch off downstream of it.

Between the injection valve element 28 and the bore 30 toward the valve seat 36, the valve body 26 is provided with an annular chamber 38, whose end region oriented away from the valve seat 36 transitions by means of a radial expansion of the bore 30 into a pressure chamber 40 encompassing the injection valve element 28. At the level of the pressure chamber 40, the injection valve element 28 has a pressure shoulder 42, which is formed by a cross sectional reduction and points toward the valve seat 36. A prestressed closing spring 44 engages the end of the injection valve element 28 oriented away from the combustion chamber and presses the injection valve element 28 with its sealing surface 34 toward the valve seat 36. The closing spring 44 is disposed in a spring chamber 46, which adjoins the bore 30. The pressure chamber 40 is connected to the pump working chamber 20 by means of a conduit 48 extending through the valve body 26 and the pump body 16.

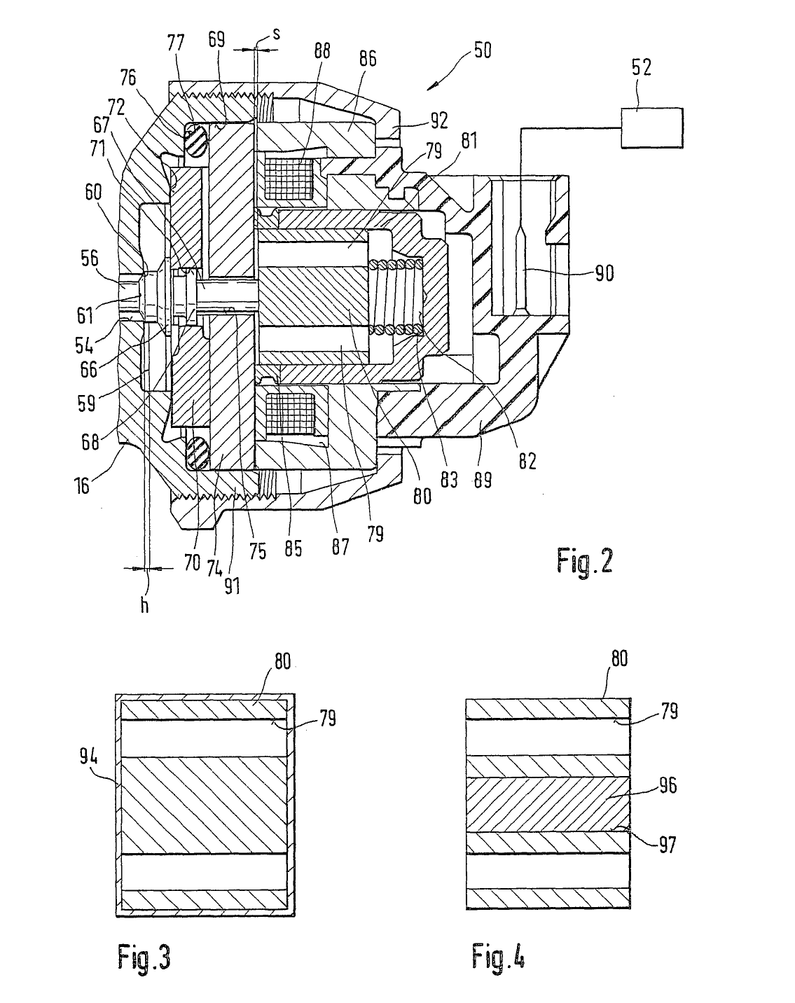

In order to control the fuel injection through the fuel injection apparatus, the fuel injection apparatus has a solenoid valve 50, which is depicted in an enlarged view in FIG. 2 and is controlled by means of an electronic control unit 52. The solenoid valve 50 controls a connection of the pump working chamber 20 to a relief chamber; when the solenoid valve 50 is open, the connection of the pump working chamber 20 to the relief chamber is open so that high pressure cannot build up in the pump working chamber 20 and no fuel injection takes place. When the solenoid valve 50 is closed, then this shuts off the pump working chamber 20 from the relief chamber so that high pressure can build up in the pump working chamber 20 in accordance with the stroke of the pump piston 18 and a fuel injection can take place. The solenoid valve 50 is disposed on the pump body 16 for example laterally and has a valve element 56 that is guided in a bore 54 of the pump body 16. The bore 54 extends crosswise, for example at least approximately perpendicular to the cylinder bore 14. The bore 54 has a radial expansion 55, from which a connecting bore 58 leads into the pump working chamber 20.

The bore 54 feeds into an annular chamber 59 in the pump body 16 and the cross section of this annular chamber 59 is greater than that of the bore 54; the mouth of the bore 54 widens out, for example, in an approximately conical shape and forms a valve seat 60. In its end region protruding of from the bore 54 into the annular chamber 59, the valve element 56 has a larger cross section than in the bore 54, thus providing the valve element 56 with a for example approximately conical sealing surface 61 oriented toward the valve seat 60, which cooperates with this valve seat 60. The annular chamber 59 contains a mouth of a connecting bore 62 that leads to a relief chamber, which function is fulfilled at least indirectly by the fuel tank, for example. When the sealing surface 61 of the valve element 56 rests against the valve seat 60, then the pump working chamber 20 is shut off from the relief chamber and when the sealing surface 61 of the valve element 56 is spaced apart from the valve seat 60, then the pump working chamber 20 is connected to the relief chamber. In the open position of the valve element 56, during the intake stroke of the pump piston 18, fuel is sucked into the pump working chamber 20 through the connecting bore 62. In the open position of the valve element 56, high pressure cannot build up in the pump working chamber 20 and in the pressure chamber 40 of the fuel injection valve 12 connected to it via the conduit 48 so that the closing spring 44, which holds the sealing surface 34 of the injection valve element 28 in contact with the valve seat 36, closes the fuel injection valve 12 and no fuel injection takes place. In the closed position of the valve element 56, high pressure builds up in the pump working chamber 20 and in the pressure chamber 40 in accordance with the stroke of the pump piston 18. When the pressure in the pressure chamber 40 is high enough for the force in the opening direction that it exerts on the injection valve element 28 by means of the pressure shoulder 42 to exceed the closing force that the closing spring 44 exerts on the injection valve element 28, then the sealing surface 34 of the injection valve element 28 lifts up from the valve seat 36 and unblocks the injection openings 32 through which fuel is injected into the combustion chamber. When the pressure in the pressure chamber 40 falls back to the point at which the compressive force that this pressure exerts by means of the pressure shoulder 42 is less than the force of the closing spring 44, then the fuel injection valve 12 closes again and the fuel injection is terminated.

The end region of the valve element 56 oriented away from the solenoid valve 50 is engaged by a prestressed compression spring 64, which acts on the valve element 56 in its opening direction, i.e. in a direction away from the valve seat 60. On one end, the spring 64 is at least indirectly supported against the valve element 56 and on the other end, it is supported against a cover 65 that is inserted into the pump body 16 and closes the bore 54. In its end region protruding into the annular chamber 59, the valve element 56 has a cross sectionally enlarged flange 66 and on this flange, oriented axially away from the sealing surface 61, has a cylindrical section 67 on which, spaced apart from the flange 66, a cross sectionally enlarged annular collar 68 is provided. The annular chamber 59 is embodied in a bore 69 with a multiply stepped diameter in the pump body 16 and in the axial direction oriented away from the pump body 16, is delimited by a stop ring 70, which is inserted into a section of the bore 69 that has a somewhat greater diameter than the annular chamber 59. The stop ring 70 has a bore 71 that the cylindrical section 67 of the valve element 56 reaches through. The bore 71 in the stop ring 70 is only slightly larger in diameter than the annular collar 68 of the valve element 56, which is contained in the bore 71. The bore 71 in the stop ring 70 is smaller in diameter than the flange 66 of the valve element 56, which as a result cannot travel into the bore 71. In the axial direction toward the pump body 16, the stop ring 70 rests against the pump body 16 on a stop shoulder 72 in the bore 69. The valve element 56 is guided with its annular collar 68 in the bore 71 of the stop ring 70, with a slight amount of play.

The section of the bore 69 containing the stop ring 70 is adjoined by another diametrically enlarged section of the bore 69 that contains a magnetic disk 74, which is a component of the solenoid valve 50. The magnetic disk 74 has a bore 75 into which the cylindrical section 67 of the valve element 56 protrudes. An elastic sealing ring 77 is clamped between the magnetic disk 74 and an annular shoulder 76, which is embodied in the pump body 16 and encompasses the stop ring 70.

The solenoid valve 50 has a movable magnetic armature 80, against which the valve element 56 rests with the end face of its end protruding from the bore 75 of the magnetic disk 74. The magnetic armature 80 is embodied as approximately cylindrical and is disposed in a cup-shaped capsule 81 so that it can move approximately coaxial to the valve element 56. The magnetic armature 80 is guided by means of its circumference surface in the capsule 81. The magnetic armature 80 can have one or more axial through bores 79. The end face of the valve element 56 rests against the end face of the magnetic armature 80 oriented toward the magnetic disk 74. Between the bottom 82 of the capsule 81, which is situated at the end of the capsule 81 oriented away from the magnetic disk 74, and the end face of the magnetic armature 80 oriented away from the magnetic disk 74, a prestressed compression spring 83 is provided, which acts on the magnetic armature 80 in the direction of the magnetic disk 74. The force that the compression spring 83 exerts on the magnetic armature 80 is weaker than the force that the compression spring 64 exerts on the valve element 56. The compression spring 64 acting on the valve element 56 and the compression spring 83 acting on the magnetic armature 80 assure a contact of the valve element 56 against the magnetic armature 80 without these two parts being attached to each other. For example, the capsule 81 can be made of steel and can be plasma-nitride treated.

Between the capsule 81 and the magnetic disk 74, there is a ring 85, which is attached, in particular welded, to the capsule 81 on one side and to the magnetic disk 74 on the other. The ring 85 is comprised of non-magnetizable material. The magnetic disk 74 constitutes a sort of cover, which closes the capsule 81, and the magnetic armature 80 is disposed in the inner chamber delimited by the capsule 81 and the magnetic disk 74. The capsule 81 is inserted into a hollow, approximately cylindrical support 86, which has an outer diameter that is at least approximately the same size as the outer diameter of the magnetic disk 74. On the side oriented toward the magnetic disk 74, the inner circumference of the support 86 contains a radial recess 87 into which a magnetic coil 88 is inserted. The magnetic coil 88 is affixed in the recess in the axial direction between the support 86 and the magnetic disk 74. The support 86 is attached to a connecting body 89 preferably comprised of plastic, which contains electric conductor elements, which are connected at one end to the magnetic coil 88 and are connected at the other end to plug contacts 90, which a plug connector that is not shown can connect to electrical lines leading to the control unit 52.

The bore 69 is embodied in a hollow, approximately cylindrical extension 91 of the pump body 16, which is provided with an external thread on its outer circumference. A union nut 92 is slid over the support 86 of the solenoid valve 50 and is screwed onto the external thread of the extension 91 of the pump body 16 and thus serves to attach the solenoid valve 50 to the pump body 16. The union nut 92 acts on the support 86, which rests against the magnetic disk 74, which in turn rests against the stop ring 70, which rests against the stop shoulder 72 of the pump body 16. The magnetic disk 74 elastically compresses the sealing ring 77 when it comes into contact with the stop ring 70.

The function of the solenoid valve 50 will be explained below. When the solenoid valve 88 is without current, the magnetic armature 80 is not subjected to any magnetic force. The force of the compression spring 64 holds the valve element 56 in its open position since the force of the compression spring 64 is greater than the force the compression spring 83 exerts on the magnet armature 80. The magnetic armature 80 is consequently disposed spaced axially apart from the magnetic disk 74. The movement of the valve element 56 and therefore of the magnetic armature 80 in the opening direction is limited by the fact that the flange 66 of the valve element 56 comes into contact with the stop ring 74. If the solenoid valve 50 is to be closed, then the control unit 52 supplies the magnetic coil 88 with current so that the magnetic coil 88, the magnetic disk 74, and the magnetic armature 80 constitute a closed magnetic circuit and the magnetic disk 74 attracts the magnetic armature 80. The force that the compression spring 83 and the magnetic disk 74 exert on the magnetic armature 80 is greater than the force that the compression spring 64 exerts on the valve element 56 so that the magnetic armature 80 moves the valve element 56 into its closed position in which its sealing surface 61 rests against the valve seat 60. The stroke that the valve element 56 executes between its open position and its closed position is dimensioned so that even in the closed position, the magnetic armature 80 is still spaced axially apart from the magnetic disk 74. The residual air gap that this provides prevents the magnetic armature 80 from sticking to the magnetic disk 74 after the magnetic coil 88 is once again without current and the magnetic armature 80 has to be moved away from the magnetic disk 74 again. The stroke h that the valve element 56 executes between its open position and its closed position is defined by the distance between the valve seat 60 contacted by the sealing surface 61 of the valve element 56 on the one hand, and the stop ring 74 contacted by the flange 66 of the valve element 56 on the other hand. The residual air gap s between the magnetic armature 80 and the magnetic disk 74 can be adjusted to the required dimension by using a stop ring 74 with an appropriately adapted thickness. For example, the stop ring 74 can be produced by a stamping process.

The magnetic armature 80 is comprised of an alloy, which at least contains iron and cobalt, the cobalt content being between 10 and 50%. Preferably, the cobalt content is between 15 and 20%; a cobalt content of approximately 17% is particularly advantageous. The indicated percentages of the cobalt content refer to the weight. This gives the magnetic armature 80 particularly advantageous magnetic properties. The control unit 52 detects and evaluates the chronological progression of the current conduction through the magnetic coil 88. The magnetic armature 80 is a movable part of the magnetic circuit, whose movement serves to change the inductivity of the magnetic circuit, which results in a particular chronological progression of the current conduction through the magnetic coil 88. If the magnetic armature 80 is no longer moving, then the inductivity is no longer changing and a characteristic change is produced in the chronological progression of the current conduction through the magnetic coil 88. In order to control the fuel injection, it is particularly important to know the time at which the solenoid valve 50 closes so that high pressure builds up in the pump working chamber 20 and the fuel injection begins. The characteristic change in the current conduction through the magnetic coil 88 permits a determination to be made as to when the magnetic armature 80 and consequently the valve element 56 have reached the closed position. If the magnetic armature 80 is produced from the material indicated above, then there is a strongly pronounced change in the current conduction through the magnetic coil 88 when the magnetic armature 80 is no longer moving, thus permitting a very precise determination to be made as to time at which the solenoid valve 50 closes and therefore time at which the injection begins.

The material of which the magnetic armature 80 is comprised in order to achieve favorable magnetic properties is not as hard as the material of which the valve element 56 is comprised. In order to prevent the contact of the valve element 56 against the magnetic armature 80 from producing an impermissibly high wear on the magnetic armature 80, the surface hardness of the magnetic armature 80 is preferably increased, at least in the vicinity of its contact with the valve element 56. In this connection, it is possible for the magnetic armature 80 to be provided in some areas with a coating 94 comprised of a material that is harder than the material of which the magnetic armature 80 is comprised, i.e. the iron/cobalt alloy. The material for the coating 94 can be a metal, in particular nickel or chrome. For example, a surface hardness of the magnetic armature 80 of approximately 700 HV can be achieved. The coating 94 can be applied only to the end face of the magnetic armature 80 against which the valve element 56 rests, can be provided over a greater region of the surface, or can be provided over the entire surface of the magnetic armature 80. In particular, the coating 94 can also be applied to the circumference surface of the magnetic armature 80 with which the magnetic armature 80 is guided in the capsule 81.

In lieu of the coating 94, the magnetic armature 80 can also be treated all over or in certain regions with a process for increasing its surface hardness. The magnetic armature 80 can be subjected to a heat treatment process and casehardened for example, can be treated with gas-nitride carburating, or can be treated through carbo-nitriding. The surface hardness of the magnetic armature 80 can be increased only on the end face of the magnetic armature 80 against which the valve element 56 rests, over a larger region of the surface, or over the entire surface of the magnetic armature 80, in particular also on the circumference surface of the magnetic armature 80 with which it is guided in the capsule 81.

Furthermore, the magnetic armature 80 can be subjected all over or in certain regions to a strain hardening process, and for example, can be treated by means of shot-peening or impact hardening. This treatment of the magnetic armature 80 can also occur only on the end face of the magnetic armature 80 against which the valve element 56 rests, over a larger region of the surface, or over the entire surface of the magnetic armature 80.

In an embodiment of the magnetic armature 80 shown in FIG. 4, it is also alternatively possible for the magnetic armature 80 to be attached to a component 96, which has an increased hardness and which the valve element 56 comes into contact with. The component 96 can, for example, be embodied in the form of a cylinder that is inserted into a bore 97 in the magnetic armature 80, in particular is press-fitted into it. The component 96 is approximately the same size in cross section or is only slightly larger than the valve element 56. The component 96 can, for example, be comprised of the same material as the valve element 56.

The use of the above-described solenoid valve 50 with the magnetic armature 80 comprised of the iron/cobalt alloy, is not limited to the described embodiment of the fuel injection apparatus in the form of a unit injector, but can also be provided in any other embodiments of fuel injection apparatuses.

1. A fuel injection apparatus for an internal combustion engine, with at least one solenoid valve (50) for controlling the fuel injection, wherein the solenoid valve (50) is triggered by an electrical control unit (52) and has a magnetic coil (88) and a movable magnetic armature (88), which can move a valve element (56) between at least two positions, characterized in that the magnetic armature (88) is at least essentially comprised of an alloy, which at least contains iron and cobalt, wherein the cobalt content is between 10% and 50%.

2. The fuel injection apparatus according to claim 1, characterized in that the cobalt content in the alloy is between 15 and 20%, preferably at least approximately 17%.

3. The fuel injection apparatus according to claim 1 or 2, characterized in that at least in a region in which it rests against the valve element (56), the magnetic armature (80) is provided with a coating (94) comprised of a metal that is harder than the alloy of which the magnetic armature (80) is comprised.

4. The fuel injection apparatus according to claim 3, characterized in that the coating (94) is comprised of chrome or nickel.

5. The fuel injection apparatus according to claim 1 or 2, characterized in that at least in a region in which it rests against the valve element (56), the magnetic armature (80) is treated with a process for increasing its surface hardness.

6. The fuel injection apparatus according to claim 5, characterized in that the magnetic armature (80) is case-hardened.

7. The fuel injection apparatus according to claim 5, characterized in that the magnetic armature (80) is treated with a nitride process, in particular a gas-nitride carburation or a carbo-nitride process.

8. The fuel injection apparatus according to claim 5, characterized in that the magnetic armature (80) is treated with a strain hardening process, in particular a shot-peening process or an impact hardening process.

9. The fuel injection apparatus according to claim 1 or 2, characterized in that the magnetic armature (80) is attached to a component (96), which is comprised of a material that is harder than the alloy of which the magnetic armature (80) is comprised, in particular is press-fitted into the magnetic armature (80), and that the magnetic armature (80) rests against the valve element (56) by means of this component (96).

10. The fuel injection apparatus according to one of the preceding claims, characterized in that the control unit (52) evaluates the chronological progression of the current conduction through the magnetic coil (88) and based on it, determines the time of a switching state of the solenoid valve (50) at which a fuel injection begins.
